(19) United States
(12) Patent Application Publication
(10) Pub. No.: US 2015/0135712 A1
(43) Pub. Date: May 21, 2015

(54) Activation Control Device

(71) Applicant: Mitsubishi Hitachi Power Systems, Ltd., Yokohama (JP)

(72) Inventors: Eunkyeong KIM, Tokyo (JP); Yasuhiro YOSHIDA, Tokyo (JP); Tatsuro YASHIKI, Tokyo (JP); Yukinori KATAGIRI, Tokyo (JP); Takuya YOSHIDA, Tokyo (JP); Kenichiro NOMURA, Yokohama (JP); Kazunori YAMANAKA, Yokohama (JP); Fumiyuki SUZUKI, Yokohama (JP); Norihiro IYANAGA, Yokohama (JP)

(21) Appl. No.: 14/546,197

(22) Filed: Nov. 18, 2014

(30) Foreign Application Priority Data
Nov. 21, 2013 (JP) 2013-241160

(51) Int. Cl. F01K 13/02

(52) U.S. Cl. CPC F01K 13/02; F05D 2260/85; F05D 2270/44
USPC 60/660

(57) ABSTRACT

A steam turbine plant activation control device is provided, which generates an activation schedule that enables a reduction in a time period required for the activation of a steam turbine plant without complex calculation such as prediction and calculation of a temperature and calculation of thermal stress. The activation control device includes: a storage circuit for storing a correlation between an initial value of a state amount parameter and a plant operation amount which includes a control reference value related to a control target amount and time lengths of phases in a process of activating the steam turbine plant; an operation amount determination circuit for determining time lengths of phases and a control reference value based on the initial value of the state amount parameter and the correlation stored in the storage circuit; and an activation schedule circuit configured to generate activation schedules of the phases based on the phase time lengths and the control reference value, which are determined by the operation amount determination circuit, and generate an activation schedule for a time period from the start to the completion of the activation of the steam turbine plant by combining the activation schedules.

### BACKGROUND OF THE INVENTION

1. Field of the Invention

The present invention relates to an activation control device for a steam turbine plant.

2. Description of the Related Art

In order to conserve fossil resources, power plants typified by wind power generation and solar power generation, which uses renewable energy, tend to increase in number. For a power plant of this kind, the amount of power generated from renewable energy greatly varies depending on seasons, weather, and the like. Thus, this kind of power plant provided with a steam turbine (steam turbine power plant) needs to reduce the time it takes for activation (or activate the power plant at a high speed) in order to quickly compensate the variation in the amount of the power for stabilization of the power system.

When the steam turbine power plant is activated, from the viewpoint of protection of constituent devices of the steam turbine plant for a time period from the start of the activation to the completion of the activation, there are set limits (constraints) for plant state amounts such as: thermal stress generated in heated parts of the steam turbine, a steam generator and the like; and differences in thermal elongation between a rotary body and a stationary body of the steam turbine. The high-speed activation of the steam turbine plant is limited by such constraints. Specifically upon the activation of the steam turbine, the temperature of a surface of a turbine rotor rapidly becomes higher than that in the inside of the turbine rotor, since the temperature and flow rate of steam flowing in the steam turbine rapidly increase. As a result, thermal stress due to the difference in temperature between the surface and inside of the turbine rotor increases. Since excessive thermal stress may reduce the life of the turbine rotor, an increase in thermal stress needs to be controlled in a range of a set limit or less. In addition, when exposed to high-temperature steam, the turbine rotor and a casing storing the turbine rotor are heated and elongated (thermal elongation) by thermal expansion, especially in the turbine axis direction. Since the turbine rotor and the casing are different from each other in structure and in heat capacity, thermal elongation difference occurs therebetween. If the thermal elongation difference increases, the turbine rotor that is a rotary body and the casing that is a stationary body may contact with each other and suffer from damage. It is, therefore, necessary to suppress the thermal elongation difference to a set limit or less. As described above, there are some constraints in activating the steam turbine and thus the activation control needs to be performed in such a manner that the constraints are satisfied.

In general, the activation of the steam turbine plant is controlled on the basis of the predefined activation schedule in such a manner that the aforementioned constraints are satisfied. The activation schedule is expressed in temporal changes of the plant state amounts for a time period from the start of the activation to the completion of the activation of the steam turbine plant. This type of activation schedule is determined in advance for each of activation modes such as hot start mode, warm start mode, and cold start mode based on a time elapsed after the stop of the steam turbine plant (refer to Japanese Patent No. 2523498 and the like). In the present specification, this activation type is referred to as mode-based activation control. In addition, JP-2011-111959-A describes activation control that enables a steam turbine plant to be activated at a high speed by executing simulation including prediction calculation of a temperature and calculation of thermal stress each time the steam turbine plant is activated and creating an activation schedule for the steam turbine plant on the basis of results of the simulation.

### SUMMARY OF THE INVENTION

In the technique described in Japanese Patent No. 2523498, the plant state amounts at the start time of the activation vary depending on a time elapsed after the stop of the steam turbine plant. Thus, if the steam turbine plant is activated at a time elapsed after the stop of the activation (at an initial state), with the elapsed time being near a boundary between activation modes, excessive margin occurs between the plant state amount and the limit. In the activation control described in Japanese Patent No. 2523498, however, the same activation schedule is used in the same activation mode regardless of a time elapsed after the stop of the activation. Even if the steam turbine plant assumes a state that can be activated at a higher speed, therefore, the steam turbine plant is activated only within a time period it takes for the activation, with the time period being determined for the activation mode.

Since, in the activation control described in JP-2011-111959-A, the activation schedule is creating by executing simulation each time the steam turbine plant is activated, the prediction calculation of a temperature and the calculation of thermal stress are complex, and the amount of information to calculate is large.

The invention has been made in view of the aforementioned circumstances. An object of the invention is to provide a steam turbine plant activation control device that is free from complex calculation such as the prediction calculation of a temperature and the calculation of thermal stress and that can generate an activation schedule that helps reduce a time period required for the activation of a steam turbine plant.

In order to accomplish the aforementioned object, a steam turbine plant activation control device according to the invention divides, for at least one of a plant state amount and a plant operation amount in a process of activating a steam turbine plant, a time period required for the activation of a steam turbine plant into a plurality of phases at a time when the plant state amount and the plant operation amount change or at a time when tendencies of the plant state amount and plant operation amount change, generates activation schedules for the phases, and generates an activation schedule for a time period from the start of the activation of the steam turbine plant to the completion of the activation of the steam turbine plant by combining the phases.

According to the invention, an activation schedule can be generated that helps reduce a time period required for the activation of the steam turbine plant, with constraints satisfied and in response to an arbitrary initial state. In addition, for example, data that has been used for the conventional mode-based activation is available, and thus signal processing can be simplified.

### BRIEF DESCRIPTION OF THE DRAWINGS

FIG. 1 is a diagram illustrating a system configuration of a steam turbine power plant according to a first embodiment of the invention.

FIG. 2 is a diagram illustrating an example of a model of an activation schedule generated by an activation control device according to the first embodiment of the invention.

FIG. 3 is a diagram illustrating a relationship between a time elapsed after the stop of the steam turbine plant and time lengths of phases.

FIG. 4 is a diagram illustrating a system configuration of a steam turbine power plant according to a second embodiment of the invention.

FIG. 5 is a diagram illustrating a relationship between the time elapsed after the stop of the steam turbine plant and a time period required for the activation of the steam turbine plant.

FIG. 6 is a diagram illustrating a system configuration of a steam turbine power plant according to a third embodiment of the invention.

FIG. 7 is a diagram illustrating a system configuration of a steam turbine power plant according to a fourth embodiment of the invention.

FIG. 8 is a flowchart of operations of a database update circuit according to the fourth embodiment of the invention.

FIG. 9 is a diagram illustrating a change in the time period required for the activation with respect to the time elapsed after the stop.

FIG. 10 is a diagram illustrating a relationship between an increase rate of a load of a heat source device and the time elapsed after the stop.

FIG. 11 is a diagram illustrating relationships between a start time of the activation of the steam turbine plant, the time period required for the activation, and a completion time of the activation.

FIG. 12 is a diagram illustrating relationships between a stop time, a desired completion time of the activation, a desired non-operation time period, and the like of the steam turbine plant.

FIG. 13 is a diagram illustrating relationships between the stop time, the desired completion time of the activation, the time period required for the activation, and the like of the steam turbine plant.

FIG. 14 is a flowchart of a method for calculating a time to start the activation.

FIG. 15 is a diagram illustrating an example of output details when a display is used as an output device according to the second embodiment of the invention.

FIG. 16 is a diagram illustrating an example of output details when a display is used as the output device according to the third embodiment of the invention.

### DESCRIPTION OF THE PREFERRED EMBODIMENTS

### First Embodiment

### Configuration

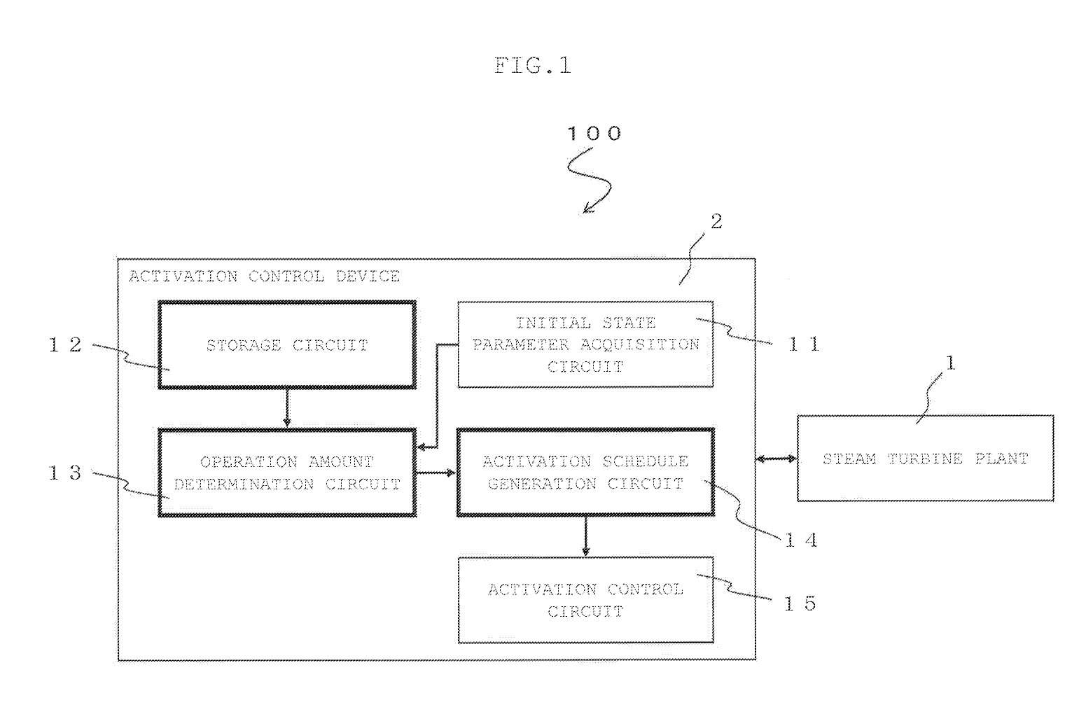

FIG. 1 is a diagram illustrating a system configuration of a steam turbine power plant 100 according to a first embodiment. As illustrated in FIG. 1, the steam turbine power plant 100 includes a steam turbine plant 1 and an activation control device (plant control device) 2. The steam turbine plant 1 and the activation control device 2 are described below.

### 1. Steam Turbine Plant

The steam turbine plant 1 includes a heat source device, a steam generator, a steam turbine, a power generator, an adjuster, and the like, which are not illustrated.

The heat source device heats a low-temperature fluid using heat held by a heat source medium, to generate a high-temperature fluid, and supplies the thus generated high-temperature fluid to the steam generator. Examples of the heat source device include a gas turbine of a combined cycle power plant, a furnace of a coal-fired power plant, a solar energy collector of a solar power plant. The steam generator has thereinside a heat exchanger in which supplied water is heated by thermal exchange with heat held by the high-temperature fluid generated by the heat source device, and thereby generates steam. The steam turbine is driven by the steam generated by the steam generator. The power generator is coupled to the steam turbine and converts driving force of the steam turbine into power. The power generated by the power generator is supplied to a power system (not illustrated), for example.

The adjuster adjusts an operation of the steam turbine plant 1. Examples of the adjuster include: a heat source medium amount adjusting unit arranged on a path through which the heat source medium is supplied to the heat source device; a low-temperature fluid amount adjusting unit arranged on a path through which the low-temperature fluid is supplied to the heat source device; a main steam adjusting valve arranged in a steam pipe system for supplying the steam from the steam generator to the steam turbine; a bypass valve branched from the steam pipe system and arranged in a bypass system for supplying the steam to another system; and a desuperheater arranged in the steam generator. The heat source medium amount adjusting unit has a function of adjusting the amount of the heat source medium to be supplied to the heat source device and adjusting the amount of heat held by the high-temperature fluid to be generated by the heat source device. The low-temperature fluid amount adjusting unit has a function of adjusting the flow rate of the low-temperature fluid to be supplied to the heat source device and adjusting the flow rate of the high-temperature fluid to be supplied from the heat source device to the steam generator. The main steam adjusting valve has a function of adjusting the flow rate of the steam to be supplied to the steam turbine. The bypass valve has a function of controlling the flow rate (bypass flow rate) of the steam that flows in the bypass system. The desuperheater has a function of reducing the temperature of the steam generated by the steam generator.

### 2. Activation Control Device

The activation control device 2 receives an initial value of a state amount parameter of the steam turbine plant 1, calculates a command value for the adjuster of the steam turbine plant 1 based on the initial value, and outputs the command value to the adjuster of the steam turbine plant 1. In order to achieve this function, the activation control device 2 includes an initial state parameter acquisition circuit 11, a storage circuit (database) 12, an operation amount determination circuit 13, an activation schedule generation circuit 14, and an activation control circuit 15. These constituent elements are sequentially described below.

### 2-1. Initial State Parameter Acquisition Circuit

The initial state parameter acquisition circuit 11 acquires initial values of state amount parameters related to plant state amounts of the steam turbine plant 1 and outputs the initial values of the state amount parameters to the operation amount determination circuit 13. The initial values of the state amount parameters of the steam turbine plant 1 are values representing states of warm air of the constituent elements upon the activation of the steam turbine plant. The state amount parameters include a time elapsed after the stop of the steam turbine plant 1, the temperatures, thermal stress, thermal elongation, thermal elongation difference, and the like of heated parts of the steam turbine plant 1. These values may be measured values, calculated values, or values predicted in advance. The heated parts include steam receiving metal of the steam turbine of the steam turbine plant 1, a turbine rotor of the steam turbine, a casing of the steam turbine, a heat transfer pipe of the steam generator of the steam turbine plant 1, a header (heat exchanger) of the steam generator, and the like.

### 2-2. Storage Circuit

The storage circuit 12 stores at least two pieces of data on correlations between an initial value of a state amount parameter of the steam turbine plant and a planned plant operation amount (hereinafter referred to as plant operation amount). The planned plant operation amount includes a control reference value related to a control target amount and multiple phase time lengths set based on the initial value of the state amount parameter.

The correlations include at least one factor of time lengths of phases. There are the following factors as the time lengths of the phases, for example.
A load increase time period for the heat source device: a time period in which a load of the heat source device continuously increases at an almost constant rate.
A load retention time period for the heat source device: a time period in which the load of the heat source device is maintained at an almost constant level in a certain load range.
A rotational speed increase time period for the steam turbine: a time period in which the rotational speed of the steam turbine is continuously increased at an almost constant rate.
A rotational speed retention time period for the steam turbine: a time period in which the rotational speed of the steam turbine is maintained at an almost constant level, so-called heat soaking period.
A load retention time period of the steam turbine: a time period in which a load of the steam turbine is maintained at an almost constant level in a certain load range.

In addition, the aforementioned correlations include at least one factor of control target amounts. There are the following factors as the control target amounts, for example.
An increase rate of the load of the heat source device: the amount of an increased load of the heat source device per unit of time.
A maintained load range of the heat source device: a defined load range in which the load of the heat source device is maintained at an almost constant level.
An increase rate of the rotational speed of the steam turbine: the amount of an increased rotational speed of the steam turbine per unit of time.
A maintained rotational speed of the steam turbine: a defined rotational speed of the steam turbine that is maintained at an almost constant level.
The temperature of the steam flowing through the steam turbine: the temperature of the steam when the steam starts flowing through the steam turbine.

### 2-3. Operation Amount Determination Circuit

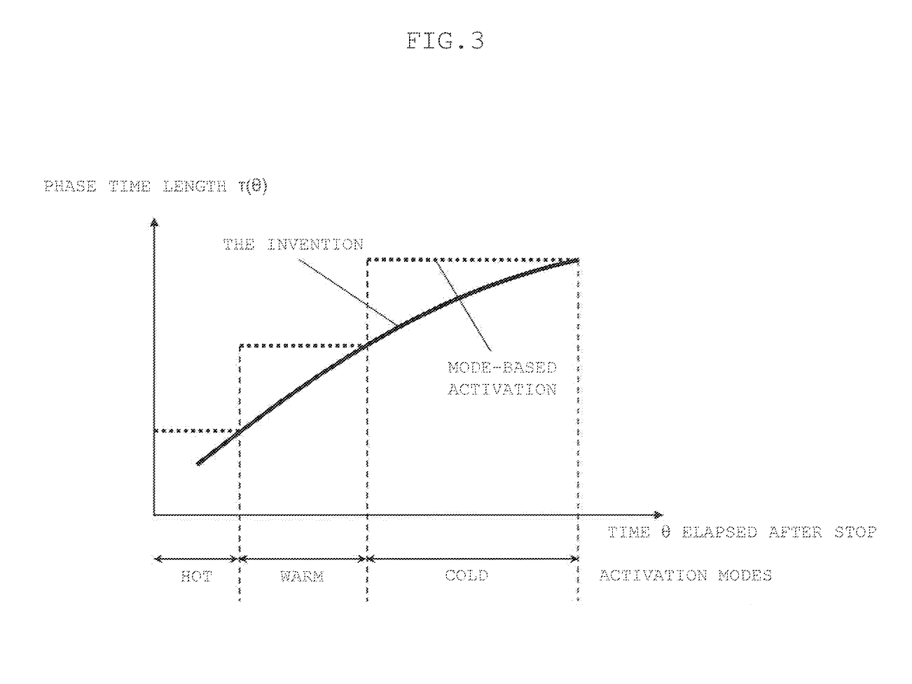

The operation amount determination circuit 13 receives the initial values of the state amount parameters of the steam turbine plant 1, which are acquired by the initial state parameter acquisition circuit 11, receives the data on the correlations between the initial values and the plant operation amounts, which are read from the storage circuit 12, and determines, based on the received initial values and the received data, line (refer to FIG. 3) representing relationships between the initial values of the state amount parameters and plant operation amounts continuously changing based on the initial values of the state amount parameters. The operation amount determination circuit 13 further outputs the determined line to the activation schedule generation circuit 14. In the present specification, the wording “continuously change” means that lines each representing the plant operation amount in each of the continuous phases are connected to each other by the same value and do not include discrete parts.

### 2-4. Activation Schedule Generation Circuit

The activation schedule generation circuit 14 receives the plant operation amounts determined by the operation amount determination circuit 13, generates activation schedules each for multiple phases based on the received plant operation amounts, and generates an activation schedule for a time period from the start of the activation of the steam turbine plant 1 to the completion of the activation by combining the activation schedules.

The activation schedules are target control lines for specific control target amounts and include a target control line for the load of the heat source device, a target control line for the rotational speed of the steam turbine, a target control line for the load of the steam turbine, and the like during a starting operation. The activation schedule generation circuit 14 generates at least one of the activation schedules.

### 2-5. Activation Control Circuit

The activation control circuit 15 calculates command values for the adjuster of the steam turbine plant 1 based on the activation schedule generated by the activation schedule generation circuits 14 and outputs the command values to the adjuster. In other words, the activation control circuit 15 causes the control target amounts such as the load of the heat source device, the rotational speed of the steam turbine, and the load of the steam turbine to be included in the activation schedule generated by the activation schedule generation circuit 14. As a method for controlling the plant, the following known control methods can be applied: a method for receiving an activation schedule for a load state of the heat source device and calculating and outputting, based on the amount of a change in the load of the heat source device, a command value to be provided to the adjuster which adjusts a load state of the heat source device; a method for receiving an activation schedule for the temperature of the fluid within the heat source device and calculating and outputting, based on the amount of the heat source medium to be supplied to the heat source device, a command value to be provided to the adjuster (valve) which adjusts the amount of the heat source medium to be supplied; and the like.

### Operations

Next, operations of generating the activation schedules are described. An operation of generating an activation schedule for the load of the heat source device in the case where a time elapsed after the stop is used as a state amount parameter is described below as an example.

In a process (activation process) from the start to the completion of the activation of the steam turbine plant, the load of the heat source device generally changes from 0% to 100% while increasing at a constant rate or an almost constant rate and being maintained at a certain level, appropriately. In the activation process, a time elapsed after the start of the activation of the steam turbine plant can be divided into a phase in which the load is increased and a phase in which the load is maintained. The phases are described below in detail.

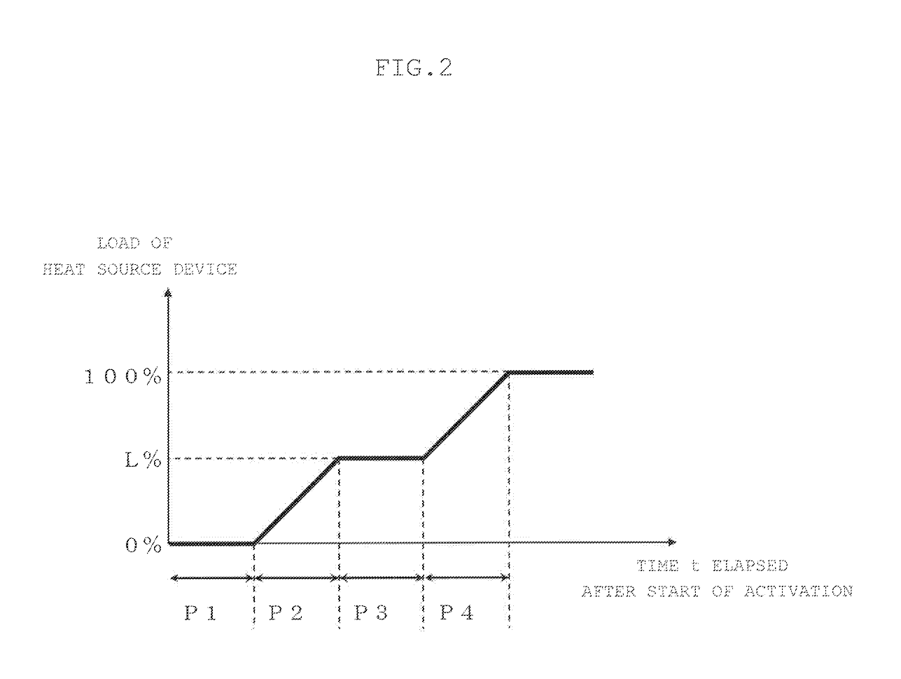

FIG. 2 is a diagram illustrating an example of a model of the activation schedule generated by the activation control device 2 according to the present embodiment. As exemplified in FIG. 2, in the activation process, if the load of the heat source device is maintained once in a maintained load range L %, the time elapsed after the start of the activation of the steam turbine plant can be divided into the following four phases.

A phase P1: a phase in which the load of the heat source device is maintained at 0%.

A phase P2: a phase in which the load of the heat source device is increased from 0% to the maintained load range L %.

A phase P3: a phase in which the load of the heat source device is maintained in the maintained load range L %.

A phase P4: a phase in which the load of the heat source device is increased from the maintained load range L % to 100%.

In this example, when the time lengths of the phases P1 to P4 and the maintained load range L are determined, the activation schedule is determined.

When an activation schedule for the rotational speed of the steam turbine is to be generated, a time period in which the rotational speed of the steam turbine is increased, an increase rate of the rotational speed of the steam turbine, a time period in which the rotational speed of the steam turbine is maintained, and the like can be treated as time lengths of phases. When an activation schedule for the load of the steam turbine is to be generated, a time period in which the load of the steam turbine is maintained and the like can be treated as time lengths of phases.

The initial state parameter acquisition circuit 11 acquires a time period (time θ elapsed after the stop) from a stop time (hereinafter referred to as stop time T1) of the steam turbine plant 1 to a planned start time (hereinafter referred to as start time T2 of the activation) of the activation of the steam power plant and outputs the time θ elapsed after the stop to the operation amount determination circuit 13.

The storage circuit 12 stores two or more groups of data related to a correlation between those selected from: data on a correlation of data θd of the time θ elapsed after the stop; phase time lengths τ1(θd), τ2(θd), τ3(θd), and τ4(θd) set based on the time θd elapsed after the stop; and the maintained load range L; to be treated as a group of data. The groups of the data group are stored in the storage circuit 12 while being arranged in a format (hereinafter referred to as correspondence table for the times θd elapsed after the stop, the time lengths τ(θd) of the phases, and the maintained load range L) that has rows (or columns) each including a time θd elapsed after the stop, the time lengths τ1(θd) to τ4(θd) of the phases, and the maintained load range L that are associated with each other. In this case, τ1(θd) is the time length of the phase P1, τ2(θd) is the time length of the phase P2, τ3(θd) is the time length of the phase P3, and τ4(θd) is the time length of the phase P4 (hereinafter, the time lengths of the phases P1 to P4 are referred to as the phase time lengths τ(θd)).

The operation amount determination circuit 13 receives the time θ elapsed after the stop from the initial state parameter acquisition circuit 11 and reads, from the correspondence table of the storage circuit 12, a group of the time θd elapsed after the stop, the phase time lengths τ(θd) set based on the time θd elapsed after the stop, and the maintained load range L. The operation amount determination circuit 13 determines, based on the read data group, phase time lengths τ(θ) that cause the plant operation amount to continuously change with respect to the time θ elapsed after the stop. A method for the determination is described later. The operation amount determination circuit 13 outputs the calculated phase time lengths τ(θ) and the maintained load range L to the activation schedule generation circuit 14.

### Method for Calculating Phase Time Lengths τ(θ)

As an example of the method for calculating the phase time lengths τ(θ), a linear interpolation method is described.

(i) If the time θ elapsed after the stop is shorter than a time θd(1) elapsed after the stop, the phase time lengths τ(θ)=τ(θd(1)).
(ii) If the time θ elapsed after the stop is equal to or longer than a time θd(2) elapsed after the stop and shorter than a time θd(N−1), the phase time lengths τ(θ) are calculated by the following equation.

While θd(n)≦θ<θd(n+1),

$$τ ( θ ) = τ ( θ d ( n ) ) + \frac{τ ( θ d ( n + 1 ) ) - τ ( θ d ( n ) )}{θ d ( n + 1 ) - θ d ( n )} ( θ - θ d ( n ) ) \qquad [ Equation 1 ]$$

(iii) If the time θ elapsed after the stop is equal to or longer than a time θd(N) elapsed after the stop, the phase time lengths τ(θ)=τ(θd(N)).

A correspondence table of the times θd elapsed after the stop and the phase time lengths τ(θd) is configured such that they are arranged in the order of the times θd elapsed after the stop are arranged in order. In the correspondence table, θd(n) represents a time elapsed after the stop in an n-th row of the correspondence table, and τ(θd(n)) indicates a phase time length corresponding to the time θd(n) elapsed after the stop. In this case, n indicates a row number (number of data) of the correspondence table, and N (N≧2) indicates the number (number of groups of data) of rows of the correspondence table.

The activation schedule generation circuit 14 receives the phase time lengths τ(θ) determined by the operation amount determination circuit 13 and the maintained load range L, generates an activation schedule based on the received phase time lengths τ(θ) and the received maintained load range L, and outputs the thus generated activation schedule to the activation control circuit 15. An example of a method for generating the activation schedule is described below.

### Method for Generating Activation Schedule

The following example is a method for generating an activation schedule LH(t) for the load (illustrated in FIG. 2) of the heat source device.

(i) In a phase (phase P1) in which a time t elapsed after the start of the activation is equal to or longer than 0 and shorter than τ1(θ),

LH(t)=0. [Equation 2]

(ii) In a phase (phase P2) in which the time t elapsed after the start of the activation is equal to or longer than τ1(θ) and shorter than (τ1(θ)+τ2(θ)),

$$LH ( t ) = \frac{L}{τ2} ( t - τ1 ) . \qquad [ Equation 3 ]$$

(iii) In a phase (phase P3) in which the time t elapsed after the start of the activation is equal to or longer than (τ1(θ)+τ2(θ)) and shorter than (τ1(θ)+τ2(θ)+τ3(θ)),

LH(t)=L. [Equation 4]

(iv) In a phase (phase P4) in which the time t elapsed after the start of the activation is equal to or longer than (τ1(θ)+τ2(θ)+τ3(θ)) and shorter than (τ1(θ)+τ2(θ)+τ3(θ)+τ4(θ)),

$$LH ( t ) = L + \frac{100 - L}{τ4} ( t - τ 1 - τ2 - τ3 ) . \qquad [ Equation 5 ]$$

A method obtained by generalizing the aforementioned activation schedule generation method with respect to the number of phases is exemplified below. The following description assumes that the load of the heat source device is maintained at a load L(k) in a phase P(m) and changed in phases (m−1) and (m+1) that precedes and succeeds the phase P(m).

(i) In the phase P(m−1) in which the time t elapsed after the start of the activation is equal to or longer than Στ(m−2) and shorter than Στ(m−1),

$$LH ( t ) = L ( k - 1 ) + \frac{L ( k ) - L ( k - 1 )}{τ ( P ( m - 1 ) )} ( t - \sum τ ( m - 2 ) ) . \qquad [ Equation 6 ]$$

(ii) In the phase P(m) in which the time t elapsed after the start of the activation is equal to or longer than Στ(m−1) and shorter than Στ(m),

LH(t)=L(k). [Equation 7]

(iii) In the phase P(m+1) in which the time t elapsed after the start of the activation is equal to or longer than Στ(m) and shorter than Στ(m+1),

$$LH ( t ) = L ( k ) + \frac{L ( k + 1 ) - L ( k )}{τ ( P ( m + 1 ) )} ( t - \sum τ ( m ) ) . \qquad [ Equation 8 ]$$

In this case, P(m) indicates an m-th phase (1≦m≦M), τ(m) indicates the time length of the phase P(m), Στ(m) is the total of the time lengths of the phases P(1) to P(m), L(k) indicates a k-th maintained load range (1≦k≦K), M indicates the number of the phases, and K indicates the number (load retention number K) of times when the load is maintained in the activation process.

The number M of the phases can be determined based on the load retention number K. For example, in FIG. 2, the load retention number K is 1, and the number M of the phases is 4.

For a correlation between the load retention number K and the maintained load range L(k) (1≦k≦K), data used to generate an activation schedule for the conventional mode-based activation can be used. The maintained load range L(k) may be calculated using the data used for the conventional mode-based activation in the same manner as the aforementioned method for calculating the phase time lengths τ(θ) so that the load range L(k) continuously changes with respect to the time θ elapsed after the stop.

### Effects

### (1) Simplification of Calculation Process

In the present embodiment, a time elapsed after the start of the activation of the steam turbine plant is divided into multiple phases, and thus the time lengths of the phases such as the load increase time period of the heat source device and the load retention time period of the heat source device can be effectively used as the basis of the generation of the activation schedules. In addition, for the data stored in the storage circuit 12, which represents the correlations between the initial values of the state amount parameters and the plant operation amounts, data of actual values used for activation schedules generated for the conventional mode-based activation can be effectively used. Thus, it is not necessary to perform a complex calculation process, compared with a case where prediction calculation are performed many times, and an activation schedule based on the initial values of the state amount parameters of the steam turbine plant can be generated in a simple manner.

### (2) Reduction in Time Required for Activation of Steam Turbine Plant

FIG. 3 is a diagram illustrating a relationship between the time θ elapsed after the stop of the steam turbine plant and the phase time length τ(θ). In FIG. 3, a solid line indicates transition of the phase time length τ(θ) according to the present embodiment, and a dotted line indicates transition of a phase time length τ(θ) in the mode-based activation. As illustrated in FIG. 3, in the mode-based activation, the phase time length τ(θ) is constant regardless of the time θ elapsed after the stop in the same mode and is set to an excessively long time length under the condition that the time θ elapsed after the stop is short in each of modes. On the other hand, in the present embodiment, the phase time length τ(θ) calculated by the operation amount determination circuit 13 continuously changes with respect to the time θ elapsed after the stop. Thus, an activation schedule LH(t) in which the phase time length τ(θ) continuously changes with respect to the time θ elapsed after the stop can be generated. In addition, the aforementioned data of the actual values can be effectively used. The actual values are values of operational results and satisfy the constraints. Thus, the activation schedule that enables a reduction in a time period required for the activation of the steam turbine plant based on the time θ elapsed after the stop while satisfying the constraints, can be generated. The data stored in the storage circuit 12 and representing the correlations between the initial values of the state amount parameters and the plant operation amounts is not limited to the aforementioned actual values. For example, theoretical values may be used if appropriate actual values do not exist. In this case, if the theoretical values are set in consideration of the constraints, an activation schedule that satisfies the constraints can be obtained in the same manner as the actual values.

### Second Embodiment

### Configuration

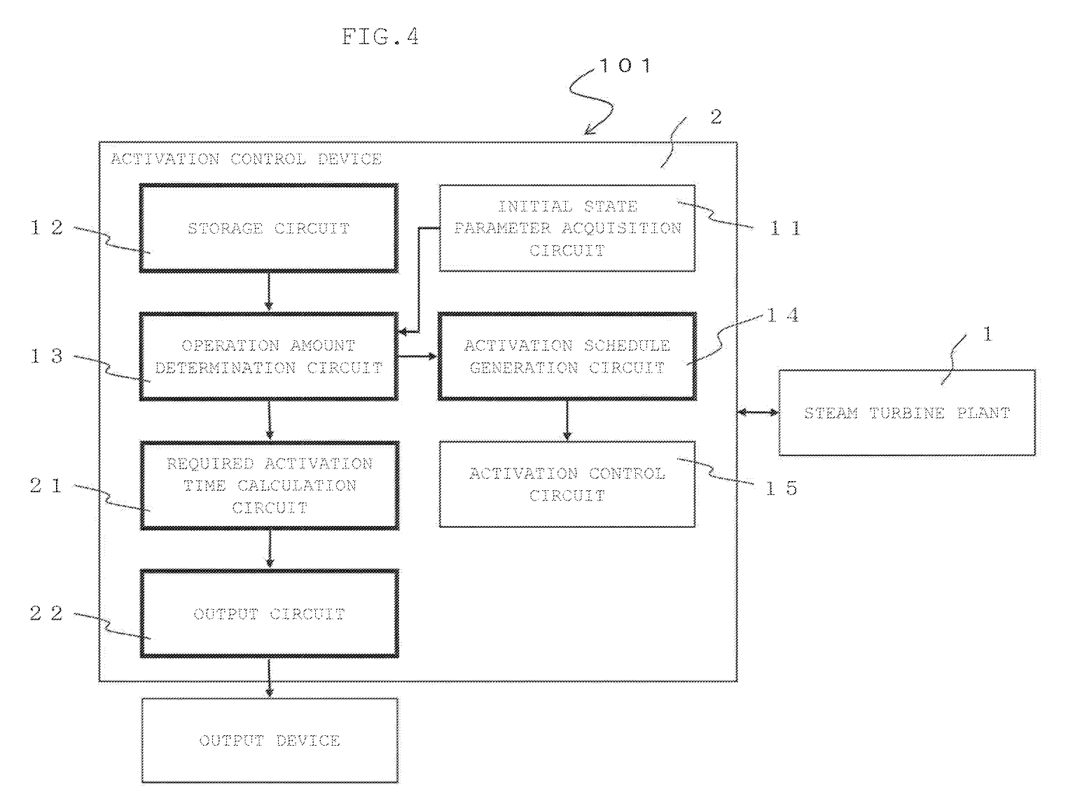

FIG. 4 is a diagram illustrating a system configuration of a steam turbine power plant 101 according to a second embodiment. Parts that are the same as or similar to those in the first embodiment are represented by the same reference numerals as the first embodiment in FIG. 4, and a description thereof is omitted.

The second embodiment is different from the first embodiment in that the activation control device 2 according to the second embodiment includes a required activation time calculation circuit 21 and an output circuit 22. The differences between the first embodiment and the second embodiment are mainly described below.

### 1. Required Activation Time Calculation Circuit

Referring to FIG. 4, the operation amount determination circuit 13 calculates the phase time lengths τ(θ) in the same manner as the first embodiment and outputs the calculated phase time length τ(θ) to the required activation time calculation circuit 21.

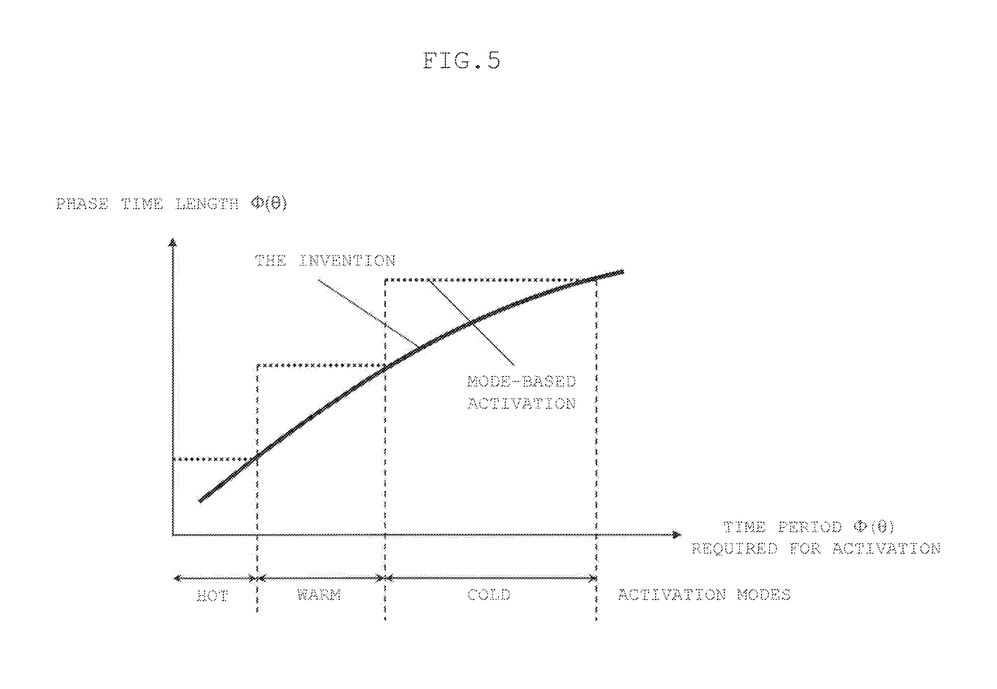

The required activation time calculation circuit 21 receives the phase time lengths τ(θ) calculated by the operation amount determination circuit 13, calculates a time period (hereinafter referred to as time period Φ(θ) required for the activation) from the start time T2 of the activation of the steam turbine plant 1 to the completion time (hereinafter referred to as completion time T3 of the activation) of the activation or the completion time T3 of the activation and outputs the calculated time period Φ(θ) required for the activation or the calculated completion time T3 of the activation to the output circuit 22. FIG. 5 is a diagram illustrating a relationship between a state amount parameter (time θ elapsed after the stop in the present embodiment) of the steam turbine plant 1 and the time period Φ(θ) required for the activation. As illustrated in FIG. 5, the time period Φ(θ) required for the activation, which is calculated by the required activation time calculation circuit 21, continuously changes with respect to the time θ elapsed after the stop. Specifically, the time period Φ(θ) required for the activation and calculated by the required activation time calculation circuit 21 continuously changes with respect to the time θ elapsed after the stop, like the phase time length τ(θ) described in the first embodiment. Methods for calculating the time period Φ(θ) required for the activation and the completion time T3 of the activation are described below.

### Method for Calculating Time Period Φ(θ) Required for Activation

The required activation time calculation circuit 21 calculates the time period Φ(θ) required for the activation as the total of the phase time lengths τ(θ) calculated by the operation amount determination circuit 13. If the activation schedule model illustrated in FIG. 2 is used, the time period Φ(θ) required for the activation is calculated according to the following equation as the total of the time lengths τ1(θ) to τ4(θ) of the phases P1 to P4.

Φ(θ)=τ1(θ)+τ2(θ)+τ3(θ)+τ4(θ)

### Method for Calculating Completion Time T3 of Activation

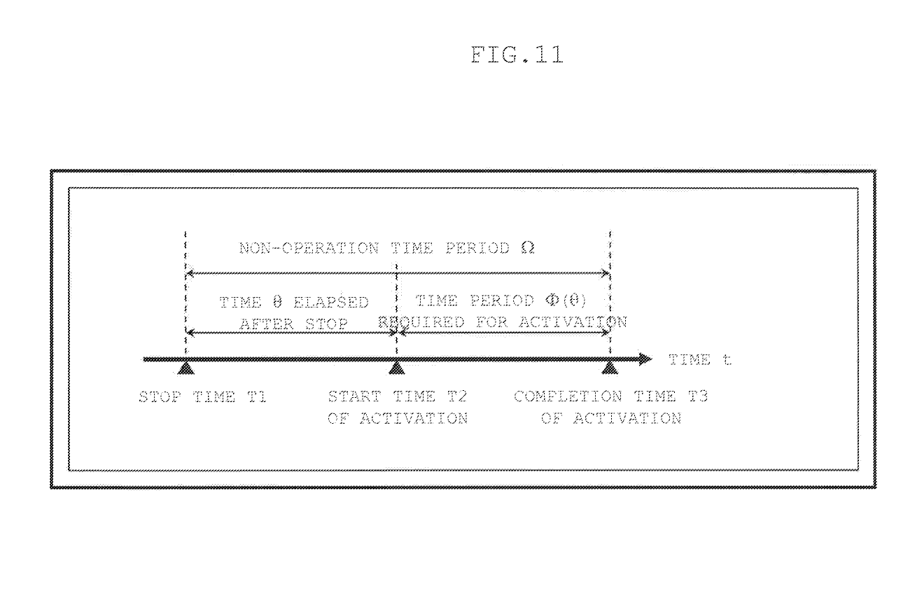

FIG. 11 is a diagram illustrating relationships between the start time T2 of the activation of the steam turbine plant 1, the time period Φ(θ) required for the activation, and the completion time T3 of the activation. As exemplified in FIG. 11, the completion time T3 of the activation is calculated as the sum of the start time T2 of the activation and the time period Φ(θ) required for the activation.

### 2. Output Circuit

As illustrated in FIG. 4, the output circuit 22 receives the time period Φ(θ) required for the activation, which is calculated by the required activation time calculation circuit 21, or the completion time T3 calculated by the required activation time calculation circuit 21 and outputs the time period Φ(θ) required for the activation or the completion time T3 of the activation to an output device. A method for outputting the time period Φ(θ) required for the activation or the completion time T3 of the activation to the output device is arbitrary as long as an operator who manages the steam turbine plant 1 can confirm the output details. As the output method, a known output method such as displaying on a display, displaying on a printing medium, or audio notification may be applied.

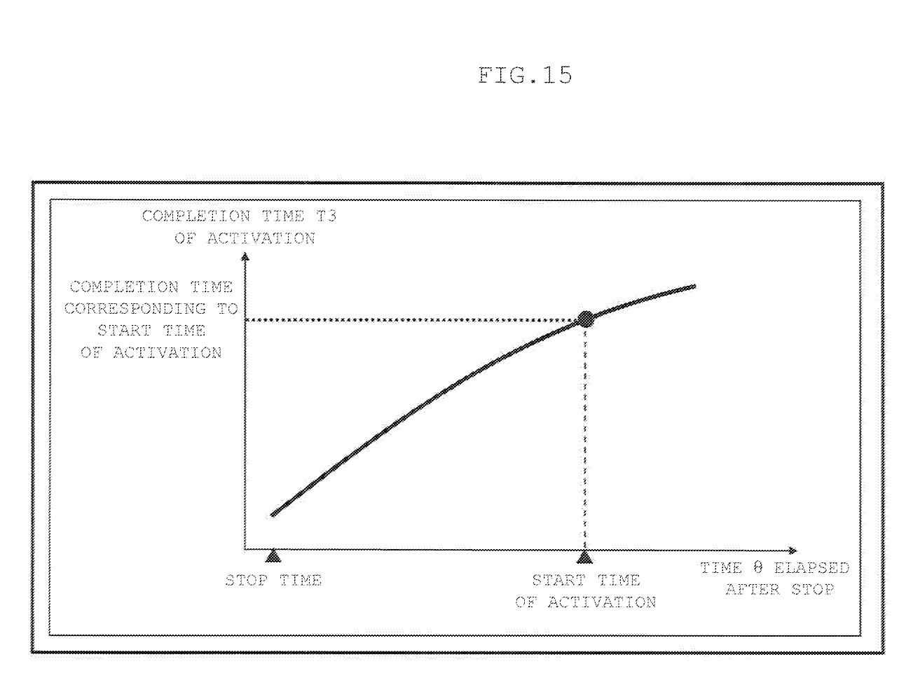

FIG. 15 is a diagram illustrating an example of the output details if a display is used as the output device according to the present embodiment. The example illustrated in FIG. 15 is a graph that represents a relationship between the time θ elapsed after the stop and the completion time T3 of the activation, wherein a stop time of the steam turbine plant 1, a planned start time of the activation, and a completion time of the activation when the activation is started at the planned start time, are displayed on the display. Multiple times θ elapsed after the stop are obtained by changing the time θ elapsed after the stop, and the graph can be generated based on data obtained by calculating time periods Φ(θ) required for the activation, which corresponds to the multiple times θ elapsed after the stop. The abscissa indicates the sum of the stop time T1 of the steam turbine plant 1 and the time θ elapsed after the stop, while the ordinate indicates the sum of the stop time T1 of the steam turbine plant 1, the time θ elapsed after the stop, and the time period Φ(θ) required for the activation.

In FIG. 15, the planned start time of the activation is a value entered by the operator who manages the steam turbine plant 1. In addition, the completion time T3 of the activation when the steam turbine plant 1 is activated at the planned start time is a value calculated based on the time period Φ(θ) required for the activation, which is calculated by the required activation time calculation circuit 21. The operator who manages the steam turbine plant 1 can confirm the stop time of the steam turbine plant 1, the planned start time of the activation, the activation completion time corresponding to the planned start time of the activation, and the like by confirming the graph.

### Effects

According to the aforementioned configuration, in addition to the effects described in the first embodiment, the following effects can be obtained in the second embodiment.

In the second embodiment, the required activation time calculation circuit 21 receives the phase time lengths τ(θ) calculated by the operation amount determination circuit 13, calculates the time period Φ(θ) required for the activation of the steam turbine plant 1 or the completion time T3 of the activation based on the thus received phase time lengths τ(θ), and outputs the calculated information to the output device through the output circuit 22. Accordingly, the operator who manages the steam turbine plant 1 can grasp the activation completion time T3 corresponding to the start time T2 of the steam turbine plant 1. Consequently, the steam turbine plant 1 can be operated according to a plan.

In addition, in the present embodiment, the graph that represents the relationship between the time θ elapsed after the stop and the completion time T3 of the activation, wherein the stop time of the steam turbine plant 1, the planned start time of the activation, the completion time of the activation when the activation is started at the planned start time, and the like, are displayed on the display. Accordingly, the operator who manages the steam turbine plant 1 can easily visually recognize the relationship between the time θ elapsed after the stop of the steam turbine plant 1 and the completion time T3 of the activation of the steam turbine plant 1 and the like. Thus, the steam turbine plant 1 can be operated according to a plan.

### Third Embodiment

### Configuration

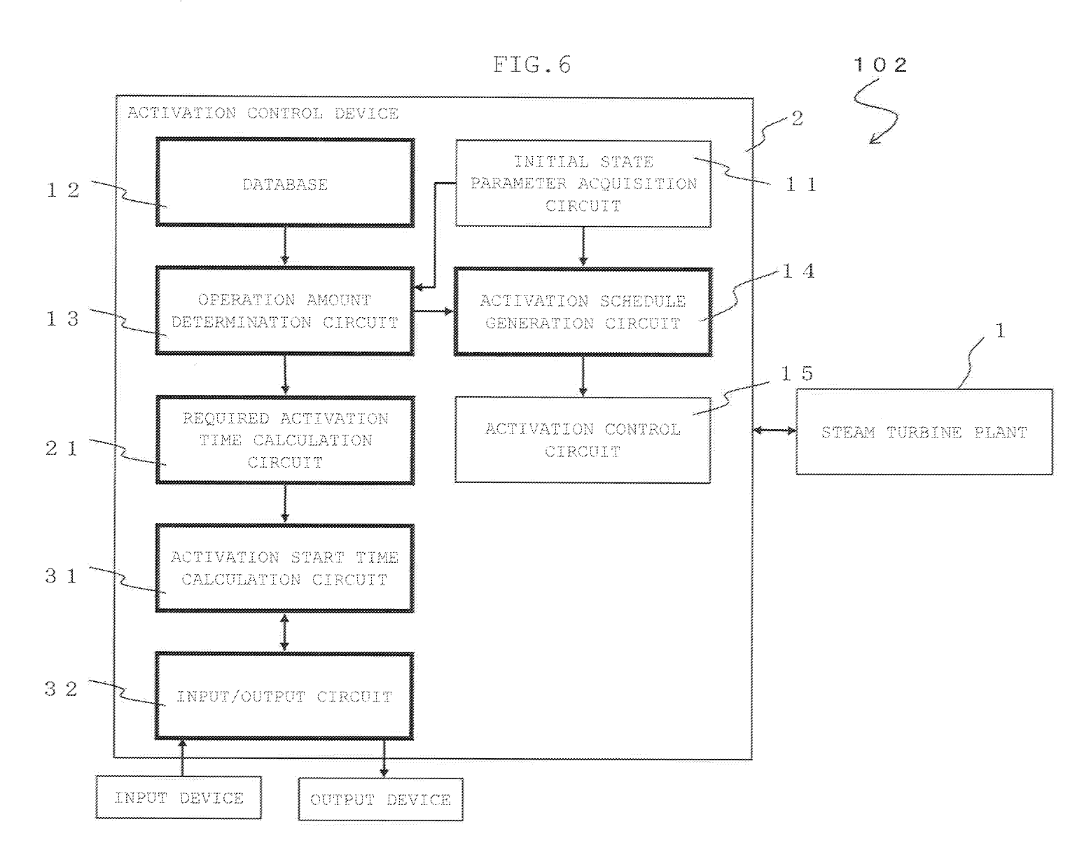

FIG. 6 is a diagram illustrating a system configuration of a steam turbine power plant 102 according to a third embodiment. Parts that are the same as or similar to those in the second embodiment are represented by the same reference numerals as the second embodiment in FIG. 6, and a description thereof is omitted.

The third embodiment is different from the second embodiment in that an activation start time calculation circuit 31 and an input/output device 32 are arranged instead of the output circuit 22. The differences between the second embodiment and the third embodiment are mainly described below.

In the third embodiment, the required activation time calculation circuit 21 changes a state amount parameter (the time θ elapsed after the stop) of the steam turbine plant 1 and calculates a time period Φ(θ) required for the activation using data obtained by calculating multiple times θ elapsed after the stop and time periods Φ(θ) required for the activation, which corresponds to the multiple times θ elapsed after the stop. The required activation time calculation circuit 21 converts the data into a format (hereinafter referred to as correspondence table of times θm elapsed after the stop and time periods Φ(θm) required for the activation) that has rows (or columns) each including a time θd elapsed after the stop and a time period Φ(θ) required for the activation, which are associated with each other. Then, the required activation time calculation circuit 21 outputs the format to the activation start time calculation circuit 31.

### 1. Activation Start Time Calculation Circuit

The activation start time calculation circuit 31 receives the correspondence table of the times θm elapsed after the stop and the time periods Φ(θm) required for the activation from the required activation time calculation circuit 21, receives from the input/output circuit 32 (described later) a completion time of the activation (hereinafter referred to as desired completion time Tn4 of the activation), which is entered by the operator of the steam turbine plant 1, and calculates a time (hereinafter referred to as time Tn2 to start the activation) when the activation of the steam turbine plant 1 is to be started for an activation completion at the desired completion time Tn4. Then, the activation start time calculation circuit 31 outputs the calculated time Tn2 to start the activation to the input/output circuit 32. An example of a method for calculating the time Tn2 to start the activation is described below.

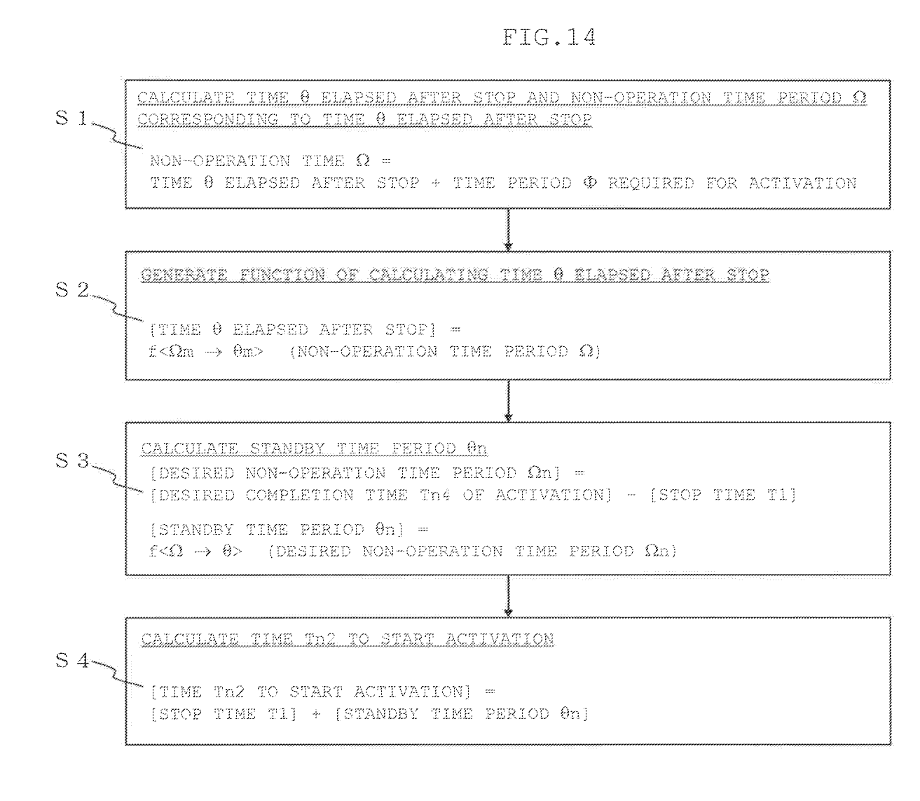

FIG. 14 is a flowchart of the method for calculating the time Tn2 to start the activation.

### Step S1

As illustrated in FIG. 14, the activation start time calculation circuit 31 calculates a time period (hereinafter referred to as non-operation time period Ω) from the stop time T1 of the steam turbine plant 1 to a completion time T3 of the next activation for each of the times θ elapsed after the stop based on the correspondence table of the times θm elapsed after the stop and the time periods Φ(θm) required for the activation. Specifically, as illustrated in FIG. 11, the non-operation time period Ω is calculated as the sum of the time θ elapsed after the stop and the time period Φ(θ) required for the activation (the non-operation time period Ω=the time θ elapsed after the stop+the time period Φ(θ) required for the activation).

### Step S2

Next, the activation start time calculation circuit 31 including prepared input columns and prepared output columns so that the lengths of the input columns are equal to the lengths of the output columns, searches an input value from the input columns. For a function of outputting a value of an output column corresponding to a searched row (or corresponding to the input value), the activation start time calculation circuit 31 further sets in an input column a non-operation time period Ωm corresponding to a time θm elapsed after the stop, which is calculated in Step S1, sets in the output column the time θm elapsed after the stop, and generates a function of calculating the time θ elapsed after the stop.

### Step S3

Next, the activation start time calculation circuit 31 calculates a time period (hereinafter referred to as desired non-operation time period Ωn) from the stop time T1 of the steam turbine plant 1 to the completion time Tn4 of the activation and a time period (hereinafter referred to as standby time period θn) from the stop time T1 of the steam turbine plant 1 to the time Tn2 to start the activation. Methods for calculating the desired non-operation time period Ωn and the standby time period θn are described below.

### Method for Calculating Desired Non-Operation Time Period Ωn

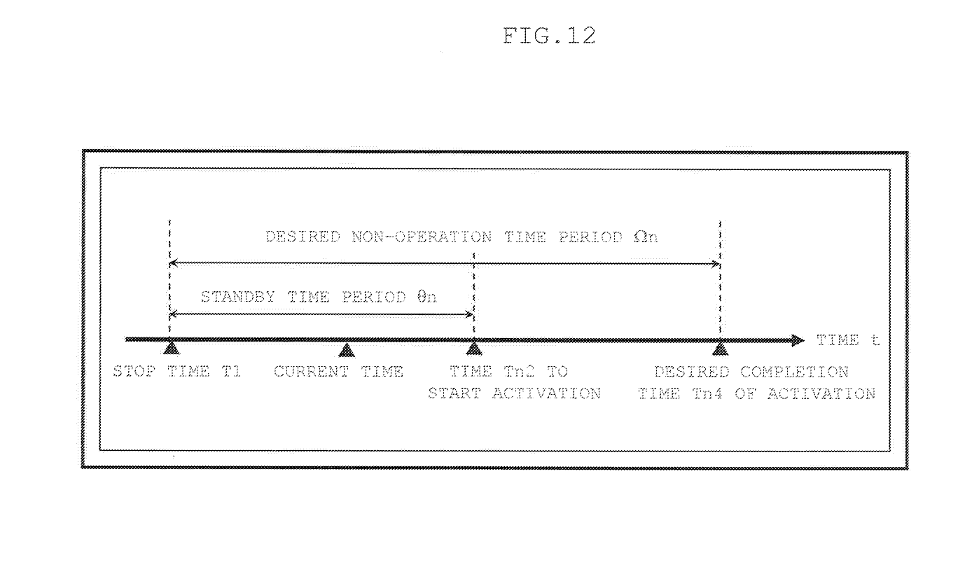

FIG. 12 is a diagram illustrating relationships between the stop time T1 of the steam turbine plant, the desired completion time Tn4 of the activation, the desired non-operation time period Ωn, and the like. As illustrated in FIG. 12, the desired non-operation time period Ωn is calculated as the difference between the desired completion time Tn4 of the activation and the stop time T1.

### Method for Calculating Standby Time Period θn

The standby time period θn is calculated by inputting the aforementioned calculated desired non-operation time period Ωn in the function of receiving the non-operation time period Ω generated in step S2 and outputting the standby time period θ. The standby time period θ is output by the calculation and is a time period from the stop time T1 to the time Tn2 to start the activation as indicated by the relationships illustrated in FIG. 12.

### Step S4

Next, the activation start time calculation circuit 31 calculates the time Tn2 to start the activation as the sum of the stop time T1 and the standby time period θn calculated in step S3, based on the relationships illustrated in FIG. 12.

In another example of the method for calculating the time Tn2 to start the activation, the time period Φ(θ) required for the activation may be used instead of the time θ elapsed after the stop. In this case, in step S2, a function of receiving the non-operation time period Ω and outputting the time period Φ(θ) required for the activation is generated instead of the function of receiving the non-operation time period Ω and outputting the time θ elapsed after the stop. Then, in step S3, the desired non-operation time period Ωn is input to this function and the time period Φ(θ) required for the activation is calculated. Then, in step S4, the standby time period θn is calculated using the relationship that represents that the non-operation time period Ω is the sum of the time θ elapsed after the stop and the time period Φ(θ) required for the activation, and the time Tn2 to start the activation is calculated based on the standby time period θn.

### 2. Input/Output Circuit

The input/output circuit 32 receives the desired activation completion time Tn4 entered through an input device by the operator who manages the steam turbine plant 1. Then, the input/output circuit 32 outputs the desired completion time Tn4 of the activation to the activation start time calculation circuit 31. In addition, the input/output circuit 32 receives the time Tn2 (calculated by the activation start time calculation 31) to start the activation in order to complete the activation at the desired completion time Tn4 of the activation and outputs the received time Tn2 to start the activation to the output device. As a method for entering the time Tn2 by the operator through the input device, a known entry method such as an entry using a keyboard may be applied. In addition, as a method for outputting the time Tn2 from the input/output circuit 32 to the output device, displaying on a display, displaying on a printing medium, or audio notification may be applied.

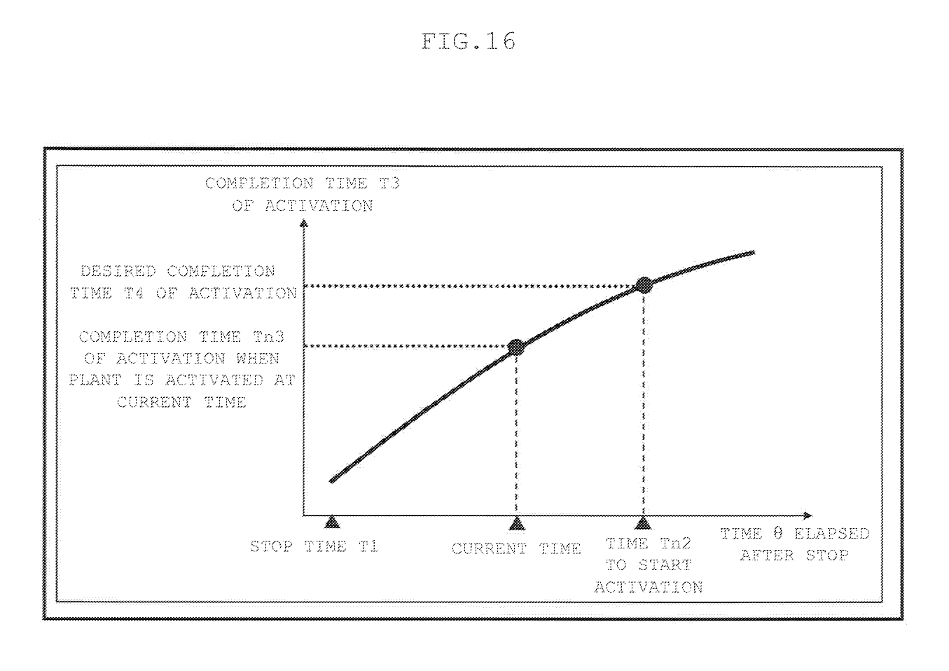

FIG. 16 is a diagram illustrating an example of the output details when the display is used as the output device according to the present embodiment. The example illustrated in FIG. 16 is a graph that represents a relationship between the time θ elapsed after the stop and the completion time T3 of the activation, wherein the stop time of the steam turbine plant 1, the desired completion time of the activation, the time to start the activation in order to complete the activation at the desired completion time, and the like are illustrated. The graph can be generated based on data obtained by changing the time θ elapsed after the stop to obtain multiple times θ elapsed after the stop and calculating non-operation time periods Ω(θ) corresponding to the multiple times θ elapsed after the stop. The abscissa indicates the sum of the stop time T1 and the time θ elapsed after the stop, while the ordinate indicates the sum of the stop time T1 and the non-operation time period Ω(θ). The desired completion time Tn4 of the activation is a value entered by the operator who manages the steam turbine plant 1, while the time Tn2 to start the activation is a value calculated by the activation start time calculation circuit 31. The current time and the completion time Tn3 of the activation when the steam turbine plant is activated at the current time can be represented. In this case, a completion time of the activation when the steam turbine plant is activated at the current time can be calculated by the activation start time calculation circuit 31.

### Effects

According to the aforementioned configuration, the effects described in the first and second embodiments and the following effects are obtained in the third embodiment.

In the third embodiment, the activation start time calculation circuit 31 calculates the time Tn2 to start the activation in order to complete the activation of the steam turbine plant 1 at the desired completion time Tn4 of the activation and outputs the calculated time Tn2 to the output device through the input/output circuit 32. Accordingly, the operator who manages the steam turbine plant 1 can recognize the time Tn2 to start the activation in order to complete the activation of the steam turbine plant 1 at the desired completion time Tn4 of the activation. Thus, the operator can efficiently activate and stop the steam turbine plant 1 according to a plan.

In addition, in the present embodiment, the graph represents the relationship between the time θ elapsed after the stop and the completion time T3 of the activation, wherein the stop time of the steam turbine plant 1, the desired completion time of the activation, the time to start the activation in order to complete the activation at the desired completion time of the activation, and the like are displayed on the display. Accordingly, the operator who manages the steam turbine plant 1 can easily visually recognize the relationship and the like between the time θ elapsed after the stop and the completion time T3 of the activation of the steam turbine plant 1. Thus, the steam turbine plant 1 can be operated according to a plan.

### Fourth Embodiment

### Configuration

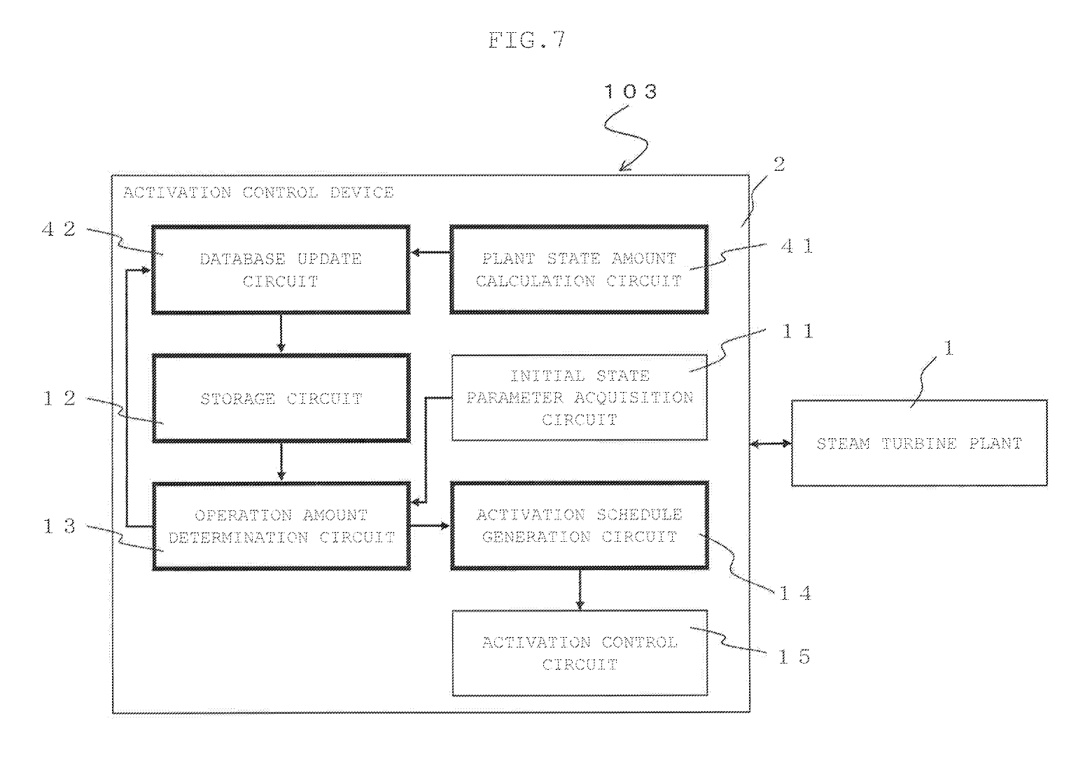

FIG. 7 is a diagram illustrating a system configuration of a steam turbine power plant 103 according to a fourth embodiment. Parts that are the same as or similar to those in the first embodiment are represented by the same reference numerals as the first embodiment in FIG. 7, and a description thereof is omitted.

The fourth embodiment is different from the first embodiment in that the activation control device 2 includes a plant state amount calculation circuit 41 and a database update circuit 42. The differences are mainly described below.

### 1. Plant State Amount Calculation Circuit

Referring to FIG. 7, the plant state amount calculation circuit 41 calculates deviations δ(θ) between the plant state amounts of the steam turbine plant 1 and limits and outputs the deviations δ(θ) to the database update circuit 42 (described later).

The plant state amounts are measured values or values calculated based on the measured values. As a method for the calculation, a known method may be applied. For example, it is sufficient if the thermal stress of the heated parts is calculated by calculating difference (temperature distribution) in temperature between the heated parts by a heat transfer equation and multiplying the temperature difference by coefficient. In addition, it is sufficient if the thermal elongation difference of the steam turbine is obtained by calculating volume mean temperatures of the rotary portion and stationary portion of the steam turbine, calculating the thermal elongation of the rotary portion of the steam turbine and the thermal elongation of the stationary portion of the steam turbine by multiplying differences between the temperatures and a reference temperature by a linear expansion coefficient, and calculating the difference between the thermal elongation of the rotary portion and the thermal elongation of the stationary portion.

### 2. Database Update Circuit

Referring to FIG. 7, the database update circuit 42 receives the deviations δ(θ) between the plant state amounts and the limits from the plant state amount calculation circuit 41 and receives the time θ elapsed after the stop and calculated by the operation amount determination circuit 13 and the phase time length τ(θ) corresponding to the time θ elapsed after the stop. If the deviations δ(θ) are equal to or larger than predetermined defined values, the database update circuit 42 outputs a signal to the storage circuit 12 and updates a database of the storage circuit 12 so that the deviations δ(θ) are reduced. For example, if the deviations δ(θ) are sufficient, the database update circuit 42 reduces the phase time lengths τ(θ) and generates a correspondence table of times θ elapsed after the stop and the phase time lengths τ(θ). If the deviations δ(θ) are not sufficient, the database update circuit 42 increases the phase time lengths τ(θ) and generates a correspondence table of times θ elapsed after the stop and the phase time lengths τ(θ). If the storage circuit 12 already stores the phase time length τ(θ) corresponding to the same time θ elapsed after the stop, the database update circuit 42 rewrites the phase time lengths τ(θ) and updates the database.

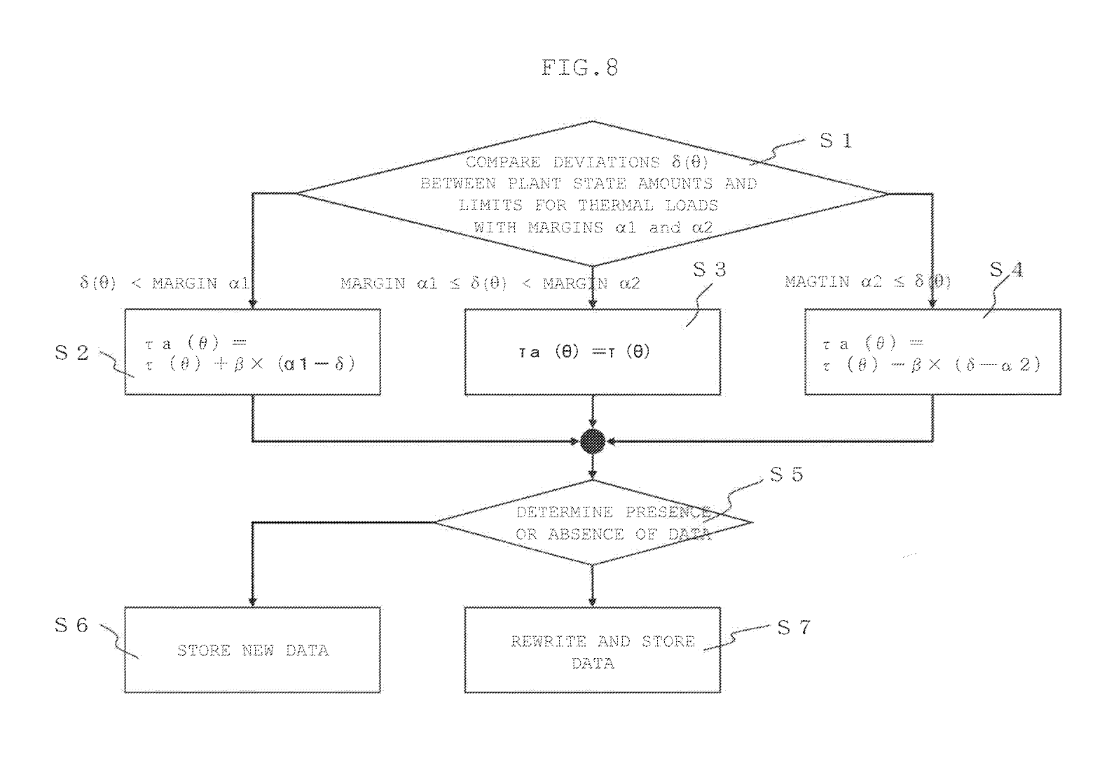

FIG. 8 is a flowchart of operations of the database update circuit 42 according to the present embodiment. An example of the aforementioned update procedure is described with reference to FIG. 8.

As illustrated in FIG. 8, the database update circuit 42 compares the deviations δ(θ) between the plant state amounts and the limits with a margin α1 and a margin α2 (α1≦α2) and causes the procedure to proceed any of steps S2 to S4 based on results of the comparison (in step S1). The margin α1 and the margin α2 are values defined in advance in consideration of an error of the measurement of temperatures, the accuracy of the calculation of the thermal stress, the thermal deformation, the thermal elongation, and the like, the accuracy of setting of the limits, and the like.

If the deviations δ(θ) are smaller than the margin α1, the database update circuit 42 calculates, based on the following equation using the differences between the deviations δ(θ) and the margin α1, phase time lengths τa(θ) updated from the phase time lengths τ(θ) so as to increase the phase time lengths τ(θ) (in step S2) and causes the procedure to step S5 (described later).

τa(θ)=τ(θ)+β×(α1−δ)

In the equation, a coefficient β reflected in the difference from the limit is a value defined in advance in consideration of an error of the measurement of temperatures, the accuracy of the calculation of the thermal stress, the thermal deformation, the thermal elongation, and the like, the accuracy of the setting of the limits, and the like.

If the deviations δ(θ) are equal to or larger than the margin α1 and smaller than the margin α2, the database update circuit 42 treats the phase time lengths τ(θ) as the updated phase time lengths τa(θ) (in step S3) and causes the procedure to proceed to step S5.

τa(θ)=τ(θ)

If the deviations δ(θ) are equal to or larger than the margin α2, the database update circuit 42 calculates, based on the following equation using the differences between the deviations δ(θ) and the margin α2, phase time lengths τa(θ) updated from the phase time lengths τ(θ) so as to reduce the phase time lengths τ(θ) (in step S4) and causes the procedure to proceed to step S5.

τa(θ)=τ(θ)−β×(δ−α2)

Next, the database update circuit 42 determines whether or not the storage circuit 12 already stores the phase time length τ(θ) corresponding to the same time θ elapsed after the stop (in step S5). If the storage circuit 12 already stores the phase time length τ(θ) corresponding to the same time θ elapsed after the stop, the procedure proceeds to step S6. If the storage circuit 12 does not store the phase time length τ(θ) corresponding to the same time θ elapsed after the stop, the procedure proceeds to step S7.

If the storage circuit 12 already stores the phase time length τ(θ) corresponding to the same time θ elapsed after the stop as a result of the determination of step S5, the database update circuit 42 deletes the phase time length τ(θ) stored in the storage circuit 12 and corresponding to the same time θ elapsed after the stop and stores the updated phase time lengths τa(θ) (in step S6).

If the storage circuit 12 does not store the phase time length τ(θ) corresponding to the same time θ elapsed after the stop as a result of the determination of step S5, the database update circuit 42 causes the storage circuit 12 to store, as new data, the standby time θ and the updated phase time length τa(θ) corresponding to the standby time θ (in step S7).

### Effects

According to the aforementioned configuration, as well as the effects described in the first embodiment, the following effects are obtained in the fourth embodiment.

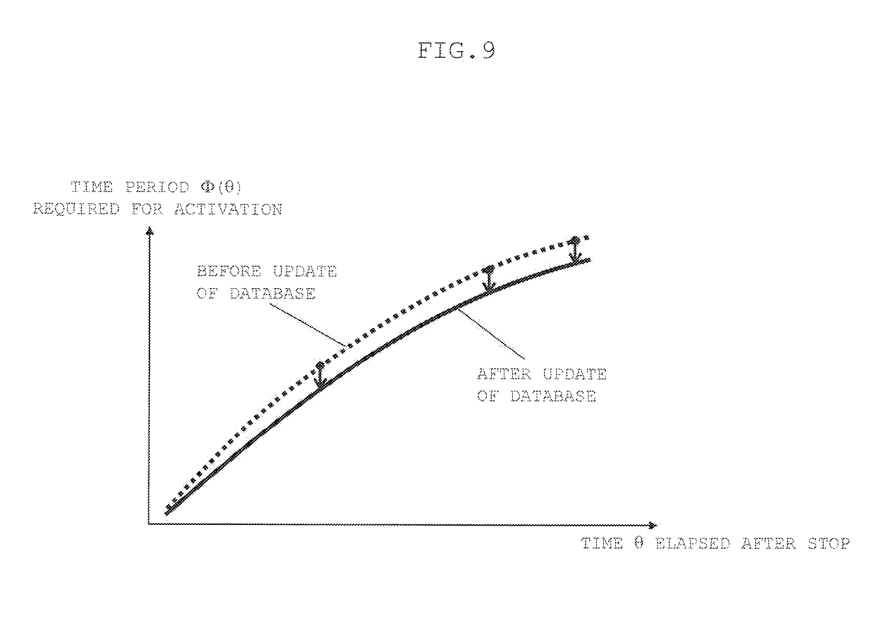

In the fourth embodiment, the plant state amount calculation circuit 41 calculates the deviations δ(θ) between the plant state amounts and the limits during an operation of the steam turbine plant 1, and the database update circuit 42 compares the deviations δ(θ) with the values defined in advance and updates the database of the storage circuit 12. Accordingly, if the deviations δ(θ) are sufficient, the database update circuit 42 calculates the phase time lengths τ(θ) so as to reduce the phase time lengths τ(θ) in step S4, and thereby enabling an activation schedule including the reduced time period Φ(θ) required for the activation to be generated. Thus, the steam turbine plant activated at a high speed is achieved (refer to FIG. 9). On the other hand, if the deviations δ(θ) are not sufficient, the database update circuit 42 calculates the phase time lengths τ(θ) so as to increase the phase time lengths τ(θ) in step S2, and thereby enabling an activation schedule including the increased time period Φ(θ) required for the activation to be generated. Thus, reductions in the plant state amounts and improvement of safety of the devices of the steam turbine plants 1 can be achieved. Consequently, the activation control device 2 can generate an activation schedule enabling a reduction in the time period required for the activation, while maintaining the plant state amounts at values equal to or lower than the limits and preventing a reduction in safety of the devices of the steam turbine plant 1.

### Others

The invention is not limited to the above embodiments disclosed, but allows various modifications. The foregoing embodiments are only meant to be illustrative, and the invention is not necessarily limited to structures having all the components disclosed. For instance, part of the components of one embodiment can be replaced by part of the components of another, or part of the components of one embodiment can be added to the components of another. Further, each of the foregoing embodiments allows addition, removal, and replacement of certain components.

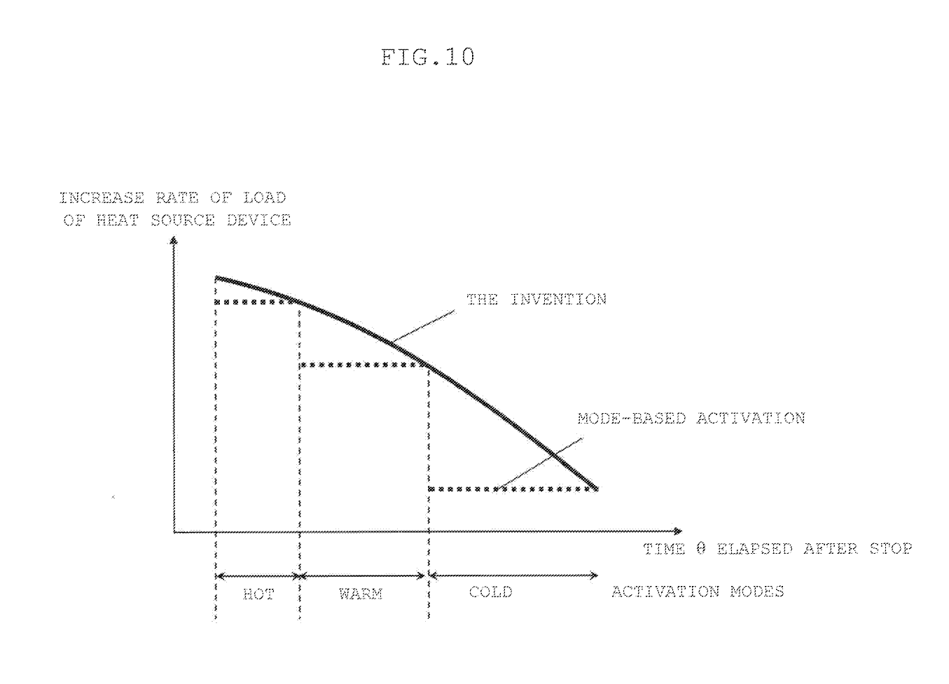

For example, the maintained load range L(k) is one of the control target values among the plant state amounts, and another control target value may be calculated instead of the maintained load range L(k). FIG. 10 is a diagram illustrating a relationship between an increase rate of the load of the heat source device and the time θ elapsed after the stop. As illustrated in FIG. 10, for example, the relationship between the increase rate of the load of the heat source device and the time θ elapsed after the stop may be calculated in the same manner as the method for calculating the phase time lengths τ(θ). The same applies to a maintained rotational speed of the steam turbine, the temperature of the steam flowing through the steam turbine, and the like.

In addition, for example, the initial state parameter acquisition circuit 11, the storage circuit 12, the operation amount determination circuit 13, and the activation schedule generation circuit 14 may start to be operated before the start time of the activation of the steam turbine plant 1. However, the operation start timing of these circuits is not limited as long as the aforementioned essential effects of the invention are obtained. For example, the timing may be a time immediately before the activation of the steam turbine plant 1 or any time during the operation of the steam turbine plant 1. If the operation start timing of these circuits is a time before the activation of the steam turbine plant 1, the operator can recognize the completion time of the activation in advance. In addition, since these circuits use existing data and thereby can suppress the amounts of data to be calculated, the activation schedule generation circuit 14 can generate an activation schedule within a short time. Further, even if the operation start timing is a time immediately before the activation of the steam turbine plant 1, an activation schedule can be generated and provided. Furthermore, even if the operation start timing is a time during the operation of the steam turbine plant 1, the activation control device 2 can control the activation while updating an activation schedule.

In addition, for example, the case where the phase time lengths τ(θ) are calculated by the operation amount determination circuit 13 using the linear interpolation method is described. The calculation method, however, is not limited to this as long as the aforementioned essential effects of the invention are obtained. Other methods for calculating the phase time lengths τ(θ) from times θ elapsed after the stop are described below.

### Calculation Method Using Approximate Equation

An approximate equation that calculates the phase time lengths τ(θ) from the times θ elapsed after the stop is generated, and the phase time lengths τ(θ) are calculated based on the approximate equation. In order to generate the approximate equation, equations such as a linear equation and a nonlinear equation are determined in advance, and coefficients of items forming the equations are determined based on the correspondence table of the times θd elapsed after the stop and the phase time lengths τ(θd), which is stored in the storage circuit 12. If the operation amount determination circuit 13 stores the above approximate equation, the activation control device 2 may not include the storage circuit 12. In this case, new data cannot be accumulated and used for the activation control to be executed at a future time, but the activation control device 2 can be formed at low cost by optimizing the use of existing data.

### Calculation Method Using Correspondence Table

An arbitrary number of multiple times θ elapsed after the stop are calculated in advance by changing the time θ elapsed after the stop, and phase time lengths τ(θ) corresponding to the multiple times θ elapsed after the stop are calculated in advance by the aforementioned linear interpolation method or the method using the approximate equation. In addition, the input columns and the output columns of which the lengths are equal to the input columns are prepared, and an input value is searched from the input columns. A function of outputting a value of an output column corresponding to a searched row (or corresponding to the input value) is prepared in advance. Then, an arbitrary one of the aforementioned times θ elapsed after the stop and a phase time length τ(θ) corresponding to the arbitrary time θ elapsed after the stop are set in an input column and output column of the function, and a function of receiving the time θ elapsed after the stop and outputting the phase time length τ(θ) is generated. Then, the phase time lengths τ(θ) are calculated using this function from the times θ elapsed after the stop. If the operation amount determination circuit 13 has the aforementioned function, the activation control device 2 may not include the storage circuit 12. In this case, new data cannot be used, like the aforementioned calculation method using the approximate equation, but the activation control device 2 can be formed at low cost by optimizing the use of existing data.

In addition, as the method for calculating the time period Φ(θ) required for the activation, the method for summing the phase time lengths τ(θ) is exemplified. However, the calculation method is not limited to this as long as the aforementioned essential effects of the invention are obtained. Other methods for calculating the time period Φ(θ) required for the activation are described below.

### Calculation Method Using Approximate Equation

An approximate equation that calculates the time period Φ(θ) required for the activation from the times θ elapsed after the stop is generated, and the time period Φ(θ) required for the activation is calculated based on the approximate equation. In order to generate the approximate equation, equations such as a linear equation and a nonlinear equation are determined in advance, and coefficients of items forming the equations are determined based on the correspondence table of the times θd elapsed after the stop and the phase time lengths τ(θd) set based on the times θd elapsed after the stop, which is stored in the storage circuit 12. The coefficients of the items may be obtained by summing the coefficients of the items of the approximate equation that calculates the phase time lengths τ(θ) from the times θd elapsed after the stop, for example. Alternatively, if the operation amount determination circuit 13 uses the approximate equation that calculates the phase time lengths τ(θ) from the times θ elapsed after the stop, the coefficients of the items of the approximate equation that calculates the time period Φ(θ) required for the activation from the times θ elapsed after the stop are determined based on the approximate equation. The coefficients of the items of the approximate equation that calculates the time period Φ(θ) required for the activation from the times θ elapsed after the stop may be obtained by summing the coefficients of the items of the approximate equation that calculates the phase time lengths τ(θ) from the times θd elapsed after the stop, for example. If the required activation time calculation circuit 21 has the approximate equation that calculates the time period Φ(θ) required for the activation from the times θ elapsed after the stop, the operation amount determination circuit 13 does not need to output a signal related to the phase time lengths τ(θ), and thus signal processing can be simplified.

### Calculation Method Using Correspondence Table

An arbitrary number of multiple times θ elapsed after the stop are calculated in advance by changing the time θ elapsed after the stop, and phase time lengths τ(θ) corresponding to the multiple times θ elapsed after the stop are calculated in advance, by the aforementioned method for summing all the phase time lengths τ(θ), the method using the approximate equation, or the like. In addition, the input columns and the output columns of which the lengths are equal to the input columns are prepared, and an input value is searched from the input columns. A function of outputting a value of an output column corresponding to a searched row (or corresponding to the input value) is prepared in advance. Then, an arbitrary one of the aforementioned times θ elapsed after the stop and a time period Φ(θ) required for the activation and corresponding to the arbitrary time θ elapsed after the stop are set in an input column and output column of the function respectively, and a function of receiving the time θ elapsed after the stop and outputting the time period Φ(θ) required for the activation is generated. Then, time period Φ(θ) required for the activation is calculated using this function from the times θ elapsed after the stop. If the required activation time calculation circuit 21 has the aforementioned function, the operation amount determination circuit 13 does not need to output a signal related to the phase time lengths τ(θ), and the signal processing can be simplified.

In addition, as an example of the output details when the display is used as the output device, the case where the graph that represents the relationship between the time θ elapsed after the stop and the completion time T3 of the activation is displayed is described. The details displayed on the display are not limited to this as long as the aforementioned essential effects of the invention are obtained. For example, as illustrated in FIG. 11, information in which the stop time T1 of the steam turbine plant 1, the start time T2 of the activation, and the completion time T3 of the activation are indicated on a single time axis may be displayed. In this case, the operator who manages the steam turbine plant 1 can grasp relationships between the stop time T1 of the steam turbine plant 1, the start time T2 of the activation, the completion time T3 of the activation, and the like with a series, and thus the steam turbine plant 1 can be operated according to a plan.

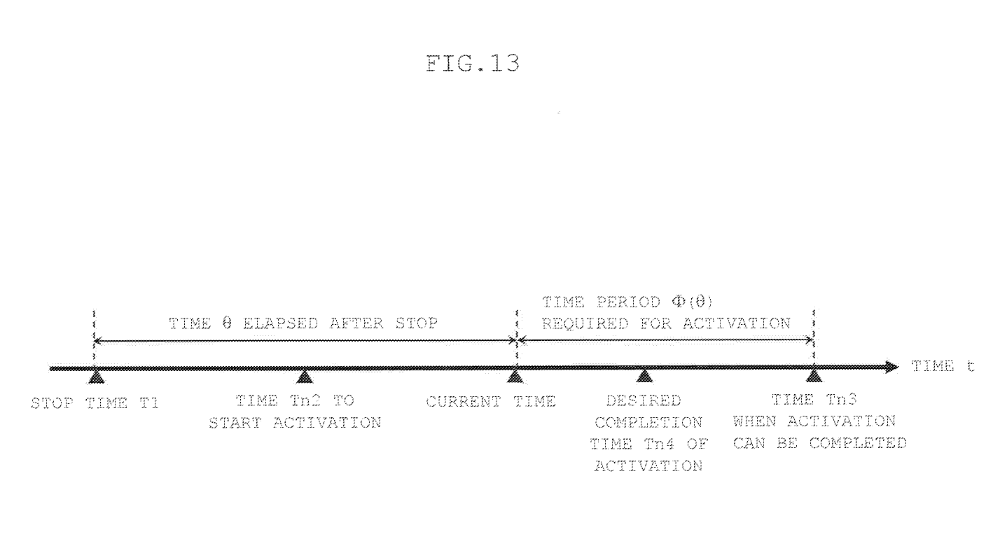

In addition, the case where the activation start time calculation circuit 31 calculates the time Tn2 to start the activation and outputs the time Tn2 to start the activation to the output device through the input/output circuit 32 is described above. However, the activation start time calculation circuit 31 is not limited to this configuration as long as the aforementioned essential effects of the invention are obtained. For example, the activation start time calculation circuit 31 may output, through the input/output circuit 32 to the output device, the time Tn2 to start the activation and a signal (hereinafter referred to as activation completion enable signal or activation completion disable signal) indicating that the activation of the steam turbine plant 1 can or cannot be completed at the desired completion time Tn4 of the activation. Operations of the activation start time calculation circuit 31 in this case are described with reference to FIGS. 12 and 13. FIG. 13 is a diagram illustrating relationships between the stop time T1 of the steam turbine plant, the desired completion time Tn4 of the activation, the time period Φ(θ) required for the activation, and the like. For example, the activation start time calculation circuit 31 compares the current time with the time Tn2 to start the activation. If the current time is before the time Tn2 to start the activation or the current time is located on the side of the stop time T1 with respect to the time Tn2 to start the activation as illustrated in FIG. 12, the activation start time calculation circuit 31 may output the activation completion enable signal at the desired completion time Tn4 of the activation. If the current time is after the time Tn2 to start the activation or the time Tn2 to start the activation is located on the side of the stop time Tn1 with respect to the current time as illustrated in FIG. 13, the activation start time calculation circuit 31 may output the activation completion disable signal at the desired completion time Tn4 of the activation.

In addition, as described above, if the activation cannot be completed at the desired completion time Tn4 of the activation, the activation start time calculation circuit 31 may calculate the time Tn3 when the activation can be completed in the case where the steam turbine plant 1 starts to be activated at the current time, and the activation start time calculation circuit 31 may output the time Tn3 when the activation can be completed to the input/output circuit 32. In this case, the activation start time calculation circuit 31 calculates a time period (time θ elapsed after the stop) from the stop time T1 to the current time, calculates a time period Φ(θ) required for the activation based on the time θ elapsed after the stop, and calculates the time Tn3 when the activation can be completed as the sum of the current time and the time period Φ(θ) required for the activation.

As described above, the activation start time calculation circuit 31 outputs the activation completion enable signal or the activation completion disable signal at the desired completion time Tn4 of the activation through the input/output circuit 32 to the output device. In addition, if the activation cannot be completed at the desired completion time Tn4 of the activation, the activation start time calculation circuit 31 outputs the time Tn3 when the activation can be completed through the input/output circuit 32 to the output device. Thus, the operator who manages the steam turbine plant 1 can recognize whether or not the activation can be completed at the desired completion time Tn4 of the activation. Further, if the activation cannot be completed at the desired completion time Tn4 of the activation, the operator can grasp the time Tn3 when the activation can be completed in the case where the steam turbine plant is activated at the current time. Thus, the operator can operate the steam turbine plant 1 according to a plan and cause the steam turbine plant 1 to flexibly handle demands for power.

In addition, the following case is described above: the activation start time calculation circuit 31 receives the correspondence table of the times θm elapsed after the stop and the time periods Φ(θm) required for the activation from the required activation time calculation circuit 21, receives the desired completion time Tn4 of the activation from the input/output circuit 32, and calculates the time Tn2 to start the activation. The activation start time calculation circuit 31, however, is not limited to this configuration as long as the aforementioned essential effects of the invention are obtained. For example, the activation start time calculation circuit 31 may have a correspondence table of the times θm elapsed after the stop and the non-operation time period Ωm or have a generated function of receiving the non-operation time period Ω and outputting the time θ elapsed after the stop. In this case, the activation start time calculation circuit 31 does not need to receive the aforementioned correspondence table from the required activation time calculation circuit 21, and thus the signal processing can be simplified.

In addition, as an example of the output details when the display is used as the output device, the following case is described: the graph that represents the relationship between the time θ elapsed after the stop and the completion time T3 of the activation is displayed. The details displayed on the display are not limited to this as long as the aforementioned essential effects of the invention are obtained. For example, as illustrated in FIG. 12, the stop time T1, the desired completion time Tn4 of the activation, the time Tn2 to start the activation, and the current time may be displayed on a single time axis on the display. The operator who manages the steam turbine plant 1 can grasp the stop time T1, the desired completion time Tn4 of the activation, the time Tn2 to start the activation, the current time, and the like from the display with a series. Thus, an operational schedule for the steam turbine plant 1 can be efficiently generated.

In addition, the plant state amount calculation circuit 41 and the database update circuit 42 can start operating before the start of the activation of the steam turbine plant 1. The operation start timing of these circuits is not limited as long as the aforementioned essential effects of the invention are obtained. For example, the plant state amount calculation circuit 41 and the database update circuit 42 may start operating at an arbitrary time including a time during the operation of the steam turbine plant 1. When these circuits start operating after the stop of the steam turbine plant 1 and before the next activation of the steam turbine plant 1, an activation schedule in which updated data is reflected can be generated upon the next activation. In addition, when these circuits start operating during the operation of the steam turbine plant 1, an activation schedule in which updated data is reflected can be generated at a time after the steam turbine plant 1 starts, and even though the time period is short from the stop of the steam turbine plant 1 to the next activation of the steam turbine plant 1, that activation schedule can be generated upon the next activation.

In addition, the activation control device according to the invention is applicable to all plants such as a combined cycle power plant, a steam power plant, a solar power plant, and the like each including a steam turbine.

For example, if the activation control device according to the invention is applied to a combined cycle power plant, fuel gas such as natural gas or hydrogen may be used as the heat source medium, a fuel gas adjusting valve may be used as the heat source medium amount adjusting unit, air may be used as the low-temperature fluid, inlet guide vanes are used as the low-temperature fluid adjusting unit, a gas turbine may be used as the heat source device, combustion gas of the gas turbine may be used as the high-temperature fluid, and an exhaust heat recovery boiler may be used as the steam generator.

In addition, if the activation control device according to the invention is applied to a steam power plant, coal or natural gas may be used as the heat source medium, a fuel adjusting valve may be used as the heat source medium amount adjusting unit, air or oxygen may be used as the low-temperature fluid, an air flow rate adjusting valve may be used as the low-temperature fluid amount adjusting unit, a furnace included in a boiler may be used as the heat source device, combustion gas may be used as the high-temperature fluid, and a heat transfer unit (steam generator) included in the boiler may be used as the steam generator.

In addition, if the activation control device according to the invention is applied to a solar power plant, sunlight may be used as the heat source medium, a device for driving a heat collecting panel may be used as the heat source medium amount adjusting unit, a medium that is oil, high-temperature solvent salt, or the like which converts solar thermal energy and holds the converted energy may be used as the low-temperature fluid and the high-temperature fluid, a flow rate adjusting valve for adjusting a flow rate of the oil, the high-temperature solvent salt, or the like may be used as the low-temperature fluid amount adjusting unit, the collecting panel may be used as the heat source device, equipment for heating supplied water to generate steam by thermal exchange with the high-temperature fluid may be used as the steam generator.

In addition, if the activation control device according to the invention is applied to a power plant including a fuel battery and a steam turbine in a combined manner, fuel gas such as a carbon monoxide or hydrogen may be used as the heat source medium, a fuel gas adjusting valve may be used as the heat source medium amount adjusting unit, air may be used as the low-temperature fluid, an air adjusting valve may be used as the low-temperature fluid amount adjusting valve, the fuel battery may be used as the heat source device, fuel battery exhaust gas may be used as the high-temperature fluid, and an exhaust heat recovery boiler may be used as the steam generator.

What is claimed is:

1. An activation control device for a steam turbine plant, the steam turbine plant including
a heat source device for heating a low-temperature fluid using a heat source medium to generate a high-temperature fluid,
a steam generator for generating steam by thermal exchange with the high-temperature fluid, and
a steam turbine driven by the steam, the activation control device comprising:
a parameter acquisition circuit for acquiring an initial value of a state amount parameter of the steam turbine plant;
a storage circuit for storing a correlation between the initial value of the state amount parameter and a plant operation amount that includes a control reference value related to a control target amount and time lengths of phases from the start to the completion of the activation of the steam turbine plant;
an operation amount determination circuit for determining time lengths of the phases and a control reference value corresponding to the initial value of the state amount parameter, based on the initial value of the state amount parameter, the initial value being acquired by the initial state parameter acquisition circuit, and based on the correlation stored in the storage circuit;
an activation schedule generation circuit for generating, for the control target amount, activation schedules of the phases based on the time lengths of the phases and the control reference value, the time lengths and the control reference value being determined by the operation amount determination circuit, the activation schedule generation circuit further generating an activation schedule for a time period from the start to the completion of the activation of the steam turbine plant by combining the activation schedules for the phases; and
an activation control circuit configured to generate a command value for the steam turbine plant in accordance with the activation schedule generated by the activation schedule generation circuit and output the generated command value to the steam turbine plant.

2. The activation control device according to claim 1,
wherein the time lengths of the phases include at least one of a time period in which a load of the heat source device is increased, a time period in which the load of the heat source device is maintained, a time period in which a rotational speed of the steam turbine is increased, a time period in which the rotational speed of the steam turbine is maintained, and a time period in which a load of the steam turbine is maintained, and
wherein the control target amount includes at least one of an increase rate of the load of the heat source device, a load range in which the load of the heat source device is maintained, an increase rate of the rotational speed of the steam turbine, a maintained rotational speed of the steam turbine, and the temperature of the steam flowing in the steam turbine.

3. The activation control device according to claim 1,
wherein the plant state amount includes at least one of a time elapsed after the stop of the steam turbine plant, the temperature of a heated part of the steam turbine plant, thermal stress of the heated part, thermal deformation of the heated part, and a difference in thermal elongation between heated parts of the steam turbine plant.

4. The activation control device according to claim 1, further comprising:
a required activation time calculation circuit for calculating a time period required for the activation of the steam turbine plant or a completion time of the activation based on the time lengths of the phases, the time lengths being output from the operation amount determination circuit; and
an output circuit for outputting, to an output device, the time period required for the activation, the time period being calculated by the required activation time calculation circuit, or the completion time of the activation, the completion time being calculated by the required activation time calculation circuit.

5. The activation control device according to claim 4, further comprising:
an input/output circuit for receiving a signal from an input device and transmitting a signal to the output device; and
an activation start time calculation circuit for calculating a time to start the activation in order to complete the activation of the steam turbine plant at the desired completion time of the activation, based on the desired completion time of the activation of the steam turbine plant, the desired completion time being input to the input/output circuit from the input device, on the initial value of the state amount parameter, and on the time period required for the activation, the time period being calculated by the required activation time calculation circuit, the activation start time calculation circuit further outputting the calculated time to start the activation to the output device through the input/output circuit.

6. The activation control device according to claim 1, further comprising:
a plant state amount calculation circuit for calculating at least one plant state amount of the steam turbine plant and calculate a deviation between the calculated plant state amount and a predetermined limit; and
a database update circuit for updating a database of the storage circuit so that the deviation is reduced if the deviation is equal to or larger than a predetermined defined value.

7. The activation control device according to claim 6,
wherein the plant state amount includes at least one of a difference in temperature between heated parts of the steam turbine, thermal stress of a heated part of the steam turbine, a difference in thermal elongation between a rotary portion and a stationary portion of the steam turbine, and the amount of deformation of a casing of the steam turbine.

8. The activation control device according to claim 4,
wherein the output device displays, based on a signal received from the output circuit, a graph that represents a relationship between the initial value of the state amount parameter and the completion time of the activation, the graph including a stop time of the steam turbine plant, a planned start time of the activation, and a completion time of the activation when the steam turbine plant is activated at the planned start time of the activation.

9. The activation control device according to claim 5,
wherein the output device displays, based on a signal received from the input/output circuit, a graph that represents a relationship between the initial value of the state amount parameter and the completion time of the activation, the graph including a stop time of the steam turbine plant, the desired completion time of the activation, and the time to start the activation.

10. A steam turbine power plant comprising:
the activation control device according to claim 1; and
the steam turbine plant.
